(19) United States
(12) Patent Application Publication
(10) Pub. No.: US 2006/0072425 A1
(43) Pub. Date: Apr. 6, 2006

(54) Array-based optical head

(76) Inventor: Darwin Mitchel Hanks, Fort Collins, CO (US)

Correspondence Address: HEWLETT-PACKARD DEVELOPMENT COMPANY;Intellectual Property Administration, P.O. Box 272400, Fort Collins, CO, 80527-2400, US

(21) Appl. No.: 10/955,704

(22) Filed: Sep. 30, 2004

(51) Int. Cl. G11B 7/00

(52) U.S. Cl. 369/112.01; 369/110.01; 369/112.16

(57) ABSTRACT

An array-based optical head is configured for read and/or write operations to optical media. In one implementation, a polarizing beam splitter is configured to direct laser light to optical media. A photo-detector array is configured to receive light modulated by reflection off a checkered pattern on the optical media and to create an output signal corresponding to the modulated light.

### RELATED APPLICATIONS

This patent application is related to U.S. patent application Ser. No. ______, titled “Array-Based Optical Storage”, filed on ______, commonly assigned herewith, and hereby incorporated by reference.

### BACKGROUND

CDs (compact discs) and DVDs (digital video (or versatile) discs) are optical disk storage media which are used to store large amounts of digital data. A typical CD includes a long spiraling track which originates near the center of the disk, and which spirals toward the edge of the disk. Information is stored by millions of bumps and flat areas (“lands”). Such a track provides for the storage of large amounts of data.

While the above system is effective, improvements in optical data processing are desirable.

### SUMMARY

While the above system is effective, greater data storage densities, as well as greater data transfer rates, are desirable. An array-based optical head is configured for read and/or write operations to optical media. In one implementation, a polarizing beam splitter is configured to direct laser light to optical media. A photodetector array is configured to receive light modulated by reflection off a checkered pattern on the optical media and to create an output signal corresponding to the modulated light.

### BRIEF DESCRIPTION OF THE DRAWINGS

The following detailed description refers to the accompanying figures. In the figures, the left-most digit(s) of a reference number identifies the figure (Fig.) in which the reference number first appears. Moreover, the same reference numbers are used throughout the drawings to reference like features and components.

FIG. 1 is an isometric view of optical media configured for reading/writing with an array-based optical head.

FIG. 2 is a diagrammatic view of a first example of an array-based optical head.

FIG. 3 is a diagrammatic view of a second example of an array-based optical head.

FIG. 4 is a block diagram illustrating examples of controllers adapted for use with the exemplary implementations of FIGS. 1 and/or 2.

FIG. 5 is a flow diagram that describes an example of a method to perform a read operation with an array-based optical head.

FIG. 6 is a flow diagram that describes an example of a method to perform a write operation with an array-based optical head.

### DETAILED DESCRIPTION

An array-based optical head is adapted for use with CDs (compact discs), DVDs (digital video (or versatile) discs) and other types of optical data-storage media. Unlike conventional optical read/write heads which detect or make single marks along an elongated spiraling data path, an implementation of the array-based optical head is configured to read and write checkered optical data patterns.

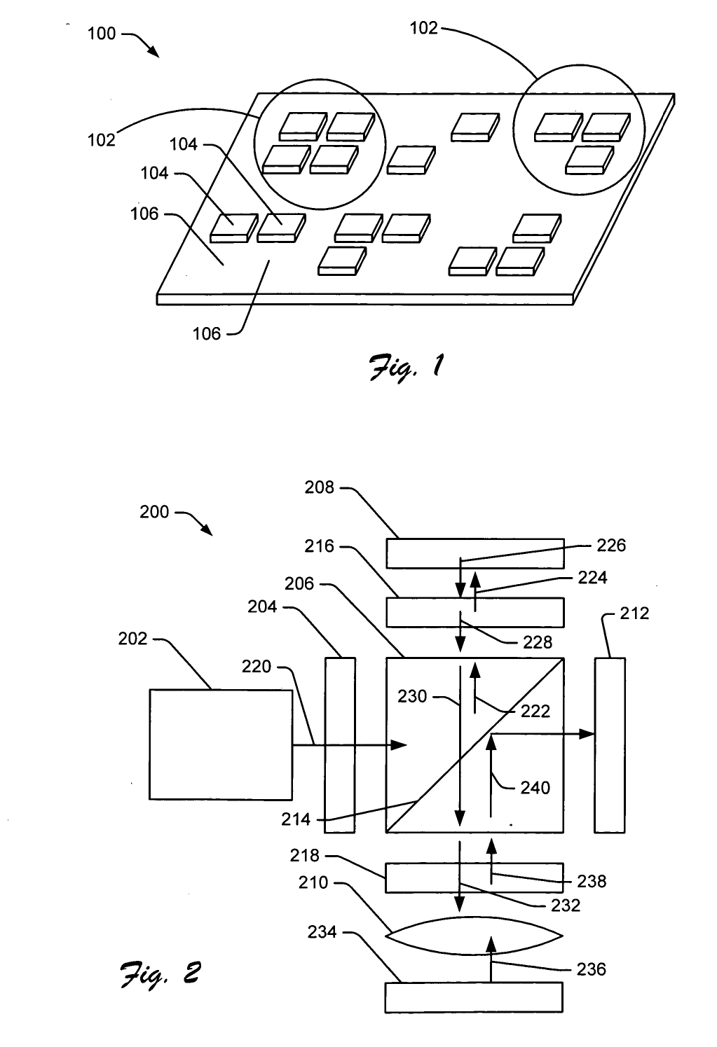

FIG. 1 shows an example of optical media 100 defining checkered optical data patterns configured for reading/writing with an array-based optical head. Two short segments of an elongated spiraling track are shown. The track is formed by an arrangement of a plurality of checkered patterns 102, which are defined on the optical media 100. Each checkered pattern 102 includes a plurality of bumps 104 and lands 106. Note that while checkered patterns formed by 2-by-2 arrays are illustrated, any M-by-N sized array could be substituted, wherein M and N are integers, which may be equal (e.g. an N by N array) and wherein at least one of M and N is greater than one. Note that while an array is generally preferred, the checkered patterns can be formed by a grouping of data elements not configured as an array.

By reading and writing checkered optical data patterns 102, rather than single marks, the array-based optical head provides greater read/write speeds, as well as greater optical media data density. Read operations are facilitated by photodetector arrays within the array-based optical head, which provide high-resolution optical sensors configured to sense patterns within light modulated by reflection from the checkered optical data patterns. Write operations are facilitated by digital light processor arrays within the array-based optical head, which provide thousands or even millions of micro-mirrors to modulate light according to a pattern, and to enable that pattern to be written to optical media.

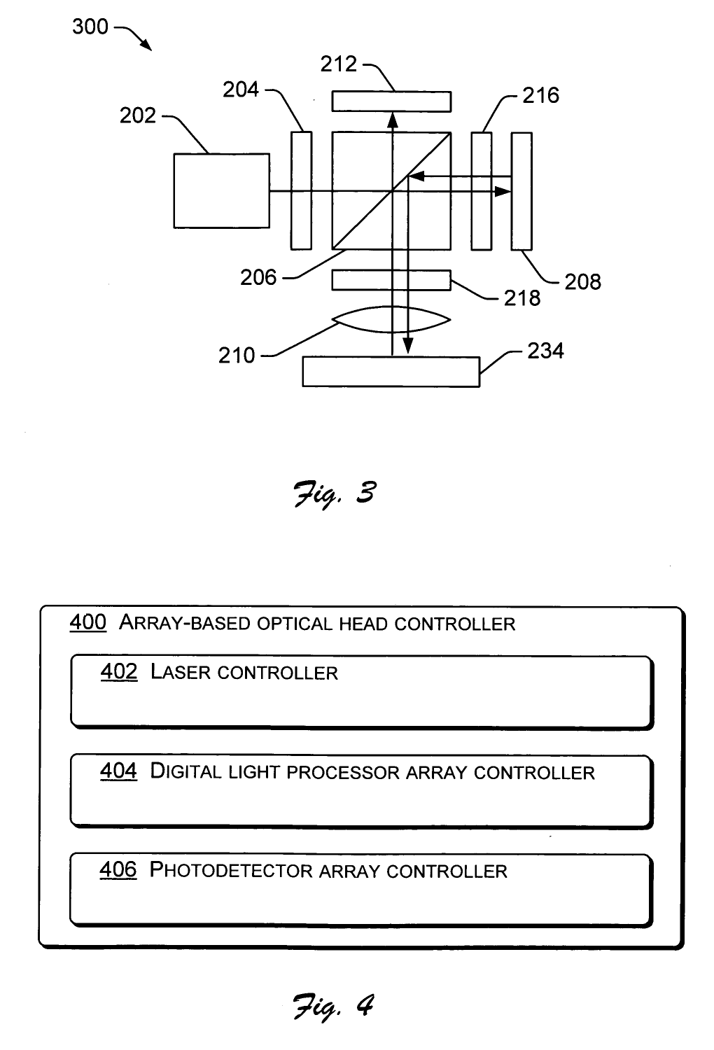

FIG. 2 is a diagrammatic view of a first exemplary implementation of an array-based optical head 200. The array-based optical head 200 includes a laser 202. The laser will typically have more than one intensity level. In particular, a lower-powered intensity level is adapted for data reading, while a higher-powered intensity level is adapted for data writing operations. Additionally, the laser 202 will be able to turn on and off at a high rate of speed. Collimating lens 204 is configured to collimate the light leaving the laser 202.

A polarizing beam splitter 206 has four optical sides, wherein a first of the four sides the laser 202, a second of the four sides a digital light processor array 208, a third of the four sides an objective lens 210 and a fourth of the four sides a photodetector array 212. In one implementation, the polarizing beam splitter 206 may be configured from two right triangle prisms. A beam splitting face 214 causes light to be redirected (i.e. reflected) at a 90 degree angle when polarization of the light is normal to the plane of incidence. The plane of incidence is the plane of the incident ray normal to the surface of the beam splitter 206. Conversely, where polarization of the light is parallel to the plane of incidence, light passes straight through the polarizing beam splitter 206 without reflection or redirection.

The digital light processor array 208 is an array comprising a plurality of microscopic mirrors (micro-mirrors). In some implementations, thousands, hundreds of thousands or even millions of mirrors are contained within the digital light processor array 208. Each microscopic mirror is individually addressable, and may be instructed to either reflect light back into the polarizing beam splitter 206, or to deflect the light into an absorber. The digital light processor array 208 is therefore useful in modulating light, i.e., the creation of light which casts a checkered pattern upon contact with a surface. For example, the digital light processor array 208 may be installed with respect to the polarizing beam splitter 206 so that light incoming from the beam splitter will strike the each microscopic mirror with approximately the same intensity. However, some micro-mirrors may be directed to reflect the light directly back to the polarizing beam splitter, while some micro-mirrors are directed to deflect the light in a direction that essentially causes the deflected light to disappear from the optical head 200. The light is considered to be modulated because some light is deflected from the system, and some light is returned. Thus, the modulated light creates a checkered pattern upon striking an object, such as the optical media. The operation of each individual mirror is controlled by a digital light processor controller, as will be seen in greater detail below.

The objective lens 210 is configured to focus light exiting the polarizing beam splitter 206 on the optical media 234. It is additionally configured to focus light reflected from the optical media for transmission to the polarizing beam splitter 206.

The photodetector array 212 is configured to detect patterns in the light modulated by reflection off checkered data patterns defined on the optical media. Accordingly, the resolution of the photodetector array 212 is typically greater than or equal to the resolution of the checkered data patterns defined on the optical media.

A first quarter-wave plate 216 is located between the polarizing beam splitter 206 and the digital light processor array 208. The quarter-wave plate 216 has the optical characteristic that the polarity of the waves of the light passing through it in both directions is rotated by 90 degrees (i.e. a quarter of a revolution). Thus, light traveling from the polarizing beam splitter 206 which is reflected off the digital light processor array 208 for return to the polarizing beam splitter 206, passes through the first quarter-wave plate twice. Accordingly, the first quarter-wave plate 216 configures the polarity of the light, so that upon its return to the polarizing beam splitter 206, it will be processed differently. That is, if the light was initially reflected at 90 degrees by the polarizing beam splitter 206 prior to the two passages (i.e., one passage in each direction) through the first quarter-wave plate 216, then the light will pass straight through on its next passage through the polarizing beam splitter 206.

A second quarter-wave plate 218 is located between the polarizing beam splitter 206 and the optical lens 210. The second quarter-wave plate 218 has similar characteristics to the first; i.e., the phase of light making two passes through the plate is rotated 90 degrees. Thus, light passing from the polarizing beam splitter 206 which is reflected off the optical media and back into the polarizing beam splitter 206 passes through the second quarter-wave plate 218 twice. Accordingly, the quarter-wave plate 218 configures the polarity of the light, so that upon its return to the polarizing beam splitter 206, it will be processed differently. That is, if the light passed straight through the polarizing beam splitter 206 prior to the passes through the second quarter-wave plate 218, then the light will be reflected at 90 degrees on its next passage through the polarizing beam splitter 206.

Referring to FIG. 2, operation of array-based optical head 200 can be better understood. The laser 202 utilizes collimating lens 204 to produce a coherent beam 220. The coherent beam 220 leaving the collimating lens 204 enters the polarizing beam splitter 206. Due to the polarity of the coherent beam 220, it is reflected by the beam splitting face 214 as reflected beam 222, which exits the polarizing beam splitter 206, toward the digital light processor array 208.

The reflected light 222 exiting the polarizing beam splitter 206 passes through a quarter-wave plate 216, which rotates the polarity of the light 222 by 90 degrees. The rotated light 224 then reflects off the micro-mirrors of the digital light processor array 208. The digital signal processor array 208 is configured to substantially reflect light during a read operation, and to modulate the light during a write operation using various micro-mirror pattern settings which correspond to data to be written.

During the read operation, the light 224 is reflected by substantially all of the micro-mirrors of the digital light processor array 208. The reflected 226 light passes through the quarter-wave plate 216 where the polarity of the light is rotated by another 90 degrees. The rotated light 228 then passes into the polarizing beam splitter 206. Because the light has twice passed through the quarter-wave plate 216, the light 230 passes straight through the polarizing beam splitter 206 to the second quarter-wave plate 218, where the polarity is again rotated 90 degrees. The rotated light 232 is then focused by the objective lens 210 onto the optical media 234.

The optical media 234 defines checkered data patterns (i.e., arrays of marks, such as bumps of lands defined on the optical media), such as the example shown in FIG. 2. When light reflects off these checkered data patterns, the reflected light is modulated. That is, if the reflected light were to strike a flat surface it would result in a checkered pattern equivalent to the checkered data pattern defined on the optical media. The reflected light 236 then passes back through the lens 210 and the second quarter-wave plate 218 for the second time, thereby rotating its polarity by another 90 degrees. Having been rotated by two passes through the quarter-wave plate 218, the twice-rotated light 238 enters the polarizing beam splitter 206. Because of the rotation of the polarity of the light 238, the polarizing beam splitter 206 reflects the light into the photodetector array 212. Application of the reflected light 240 to the photodetector array 212 produces an output signal which is representative of the data read from the optical media 234.

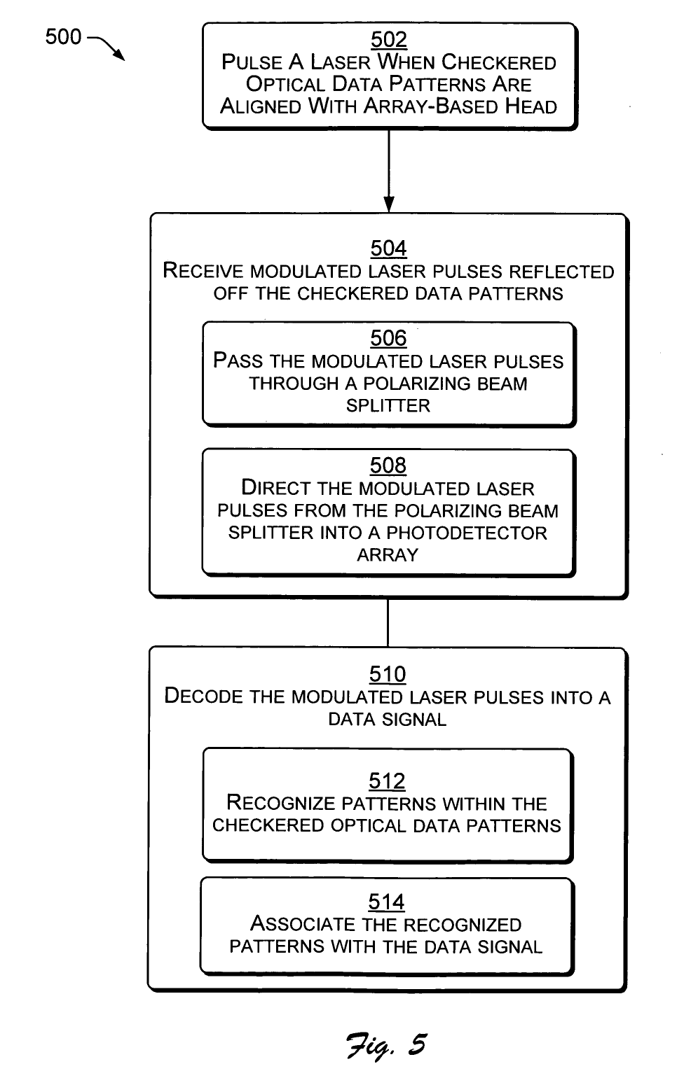

During a write operation, the light 226 is reflected by the digital light processor array 208 from a pattern of micro-mirrors which depends on the data to be written. The digital light processor array 208 is configured in a manner wherein the angle of orientation of each individual mirror contained within the array can be individually controlled. That is, depending on the data to be written, the digital light processor array controller 404 (FIG. 4) can send instructions to the digital light processor array 208 which will cause desired mirrors to reflect light straight back into the quarter-wave plate 216 and other mirrors to reflect light away from the quarter wave plate 216 and out of the system. The reflected light 226 passes through the quarter-wave plate 216 causing the polarity of the light to be rotated. As a result, the rotated light 228 passes straight through the polarizing beam splitter 206. Light emitted from the polarizing beam splitter 206 moves through an objective lens 210 before striking the optical media 236. Due to the intensity of the laser and due to the nature of the optical media 236, a checkered pattern 102 (such as that seen in FIG. 1) is formulated which corresponds to micro-mirror pattern and the underlying data (which was used to set the micro-mirrors).

FIG. 3 is a diagrammatic view of a second exemplary implementation of an array-based optical head 300. As seen by reviewing FIG. 3, the components seen in FIG. 2 can be rearranged, while still resulting in substantially similar operation. In the implementation of FIG. 2, light was reflected within the polarizing beam splitter 206 on the first and third times it entered polarizing beam splitter 206. In the implementation of FIG. 3, light passes straight through the polarizing beam splitter 206 on the first and third times it enters polarizing beam splitter 206. Thus, the concepts taught herein may be accomplished according to different implementations, as desired. Accordingly, other arrangements may also produce similar end results and is should be understood that such arrangements are within the scope of this document.

FIG. 4 is a block diagram illustrating an example of an array-based optical head controller 400 adapted for use with an array-based optical head such as those shown in the exemplary implementations of FIGS. 2 and/or 3. A laser controller 402 is configured to turn the laser 202 on and off. While during read operations the laser may optionally be left in an ON-state, during write operations the laser 202 is preferably turned off when not aligned with a location on the optical media to which application of a checkered optical pattern is intended. Cycling power as appropriate during the write mode—wherein data is written to the optical media—prevents data from being written to inappropriate locations.

A digital light processor array controller 404 is configured to control the operation of the digital light processor array 408. In particular, the digital light processor array controller 404 processes the incoming data, which is to be written to the optical media, and sends signals representing data appropriate to configuring the micro-mirrors of the digital light processor array 208. The digital light processor array 208, upon receipt of a signal from the digital light processor array controller 404, orients each mirror according to information contained within the signal. By orienting the mirrors according to the signal, light is appropriately reflected by the digital light processor array 208. In a write operation, the digital light processor array controller 404 causes selected reflective elements within the digital light processor array 208 to reflect light according to data received by the controller 404 (i.e., to modulate the light). In contrast, in most embodiments, all the mirrors are oriented to reflect light in a read operation.

A photodetector array controller 406 is configured to interpret signals generated by the photodetector array controller 406 to produce data corresponding to the data read from the optical media 234.

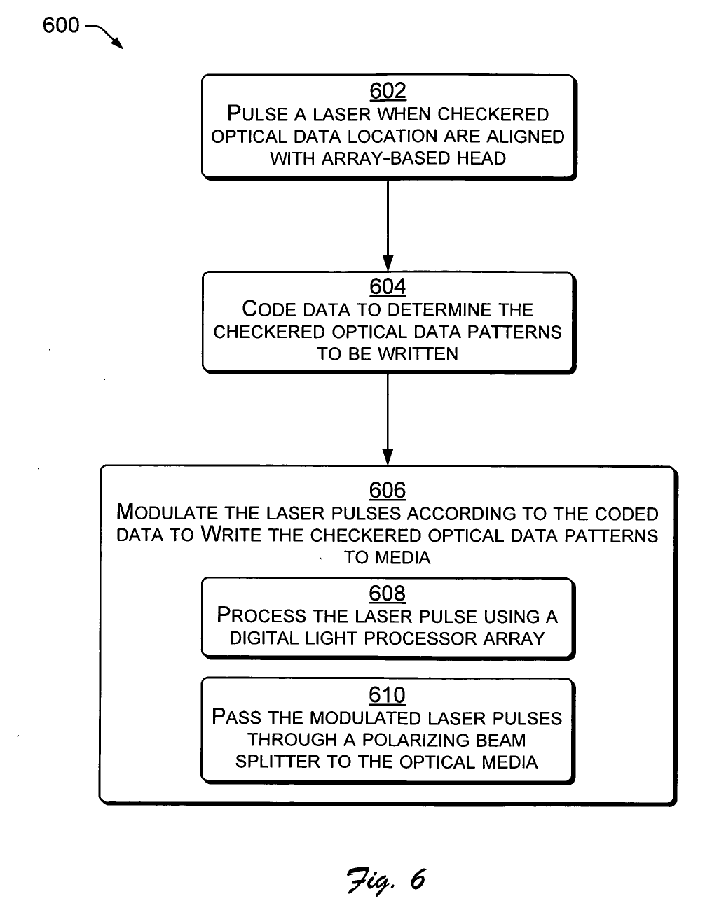

FIG. 5 is a flow diagram that describes an example of a method 500 to perform a read operation (e.g., read data off an optical media) using an array-based optical head 200. At block 502, checkered optical data patterns 102 defined on optical media (e.g., an optical disc, such as a CD or DVD) are aligned with an array-based optical head 200. In one embodiment, where the optical media includes a disc, aligning the locations defining the checkered optical data patterns 402 includes coordinating disc rotation speed and radial position of the array-based optical head. At the time of alignment, one or more laser pulses are reflected in a checkered manner off the checkered optical data patterns 102 (FIG. 1), thereby modulating the laser pulses. That is, depending on whether light hits a bump 104 (FIG. 1) or a land 106 (FIG. 1) within the checkered optical data pattern 102 (FIG. 1), the light may be reflected or dispersed. Reflection and dispersal of light according to the checkered data pattern 102 (FIG. 1) modulates the laser pulses.

At block 504, modulated laser pulses reflected off the checkered optical data patterns are received, such as by a photodetector array 212. Reception of the modulated laser pulses may be made according to the example illustrated by blocks 506-508. At block 506, modulated laser pulses are passed through a polarizing beam splitter 106. Referring briefly to FIG. 2 and to block 408 of FIG. 4, it can be seen that the polarizing beam splitter 206 reflects the light into a photodetector array 212. Similarly, referring briefly to FIG. 3 and to block 508 of FIG. 5, it can be seen that the polarizing beam splitter 206 enables light to pass straight into the photodetector array 212.

At block 510, the modulated laser pulses are decoded into data signals. This is typically performed by the array-based optical head controller 400, such as by the photodetector array controller 406. This may be performed as seen in the example of blocks 512-514. At block 512, patterns within the checkered optical data patterns 102 (FIG. 1) are recognized. For example, where the patterns are M-by-N arrays 102 (as seen in FIG. 1) the presence or absence of bumps 104 and lands 106 in each array location is recognized. At block 514, the recognized patterns are associated with a data signal, which is output. For example, each possible combination of bumps 104 and lands 106 in a checkered pattern 102 constituting an M-by-N array could be associated with data and/or a data signal. As a more specific example, a 2-by-2 array, having four elements could be associated with numbers (and corresponding signals) ranging from 0 to 15. Thus, each pattern, when recognized, is associated with data and a data signal, which is output.

Thus, in a read operation, a pulse of laser light is reflected off checkered optical data patterns defined on optical media. Accordingly, the laser pulse is thereby modulated to include information based on the checkered data patterns. Typically, the pulse is directed through a polarizing beam splitter and terminates in a photodetector array. The photodetector array is configured to decode the modulated light, thereby obtaining the read data.

FIG. 6 is a flow diagram that describes an example of a method 600 to perform a write operation with an array-based optical head 200. At block 602, a location to which a checkered optical data pattern 102 (FIG. 1) is to be defined on optical media is aligned with the optical head 600. Upon alignment, the laser 202 pulses, sending laser light through a beam splitter 206 to a digital light processor array 212. In an embodiment wherein an optical disc, such as a CD or DVD is utilized, pulsing the laser is performed as a part of a timed process wherein the media is rotated. A position of the array-based optical head is adjusted along a radius of the rotating optical media. Rotation speed of the optical media and the radial position of the array-based head are coordinated. The laser is then turned on at times when the checkered optical data patterns defined on the optical media are in alignment with the array-based optical head and, preferably, off at other times. At block 604, data is coded, thereby determining the checkered optical data patterns to be written. For example, a lookup table may be used to associate data to be written with a corresponding checkered optical data pattern.

At block 606, the laser pulses are modulated according to the checkered data pattern to be written to the optical media. This may be performed using hardware similar to that seen in FIGS. 2 and 3. For example, at block 608, the laser pulses may be processed using a digital light processor array, wherein the micro-mirrors of the digital light processor array 208 are set to modulate reflected light according to the checkered data pattern to be written. For example, by using data to be written to the optical media, individual micro-mirrors are adjusted to either reflect the laser pulse back into a polarizing beam splitter or to reflect it out of the system. At block 610, the modulated laser pulses pass through the polarizing beam splitter 206 (FIG. 2) to the optical media. Upon contact with the optical media, the modulate laser pulses create checkered data patterns 102 (FIG. 1) on the optical media.

Thus, in a write operation, a pulse of laser light is reflected off a digital light processor array prior to “burning” data onto the optical media. Specific settings applied to the micro-mirrors within the digital light processor result in modulation of the laser pulse to include information which will result in formation of checkered data patterns on the optical media consistent with the data to be written to the optical media.

Although the above disclosure has been described in language specific to structural features and/or methodological steps, it is to be understood that the appended claims are not limited to the specific features or steps described. Rather, the specific features and steps are exemplary forms of implementing this disclosure. For example, while actions described in blocks of the flow diagrams may be performed in parallel with actions described in other blocks, the actions may occur in an alternate order, or may be distributed in a manner which associates actions with more than one other block. And further, while elements of the methods disclosed are intended to be performed in any desired manner, it is anticipated that computer- and/or processor-readable instructions, performed by a computer or by a processor, typically located within the array-based optical disc drive will be utilized. While a computer- or processor-readable media could be utilized, such as a ROM (read only memory), disc or CD-ROM, an application specific integrated circuit (ASIC), gate array or similar hardware structure, could be substituted.

1. An array-based optical head, comprising:
a polarizing beam splitter, configured to direct light from a laser to optical media; and
a photodetector array to receive light modulated by reflection off a checkered pattern on the optical media and to create an output signal corresponding to the modulated light.

2. The array-based optical head of claim 1, additionally comprising:
a laser.

3. The array-based optical head of claim 1, wherein the polarizing beam splitter comprises two right angle prisms.

4. The array-based optical head of claim 1, wherein the photo-detector array has a resolution greater than or equal to a resolution of the checkered pattern on the optical media.

5. The array-based optical head of claim 1, wherein the photo-detector array is in-line to light entering the polarizing beam splitter.

6. The array-based optical head of claim 1, wherein the photo-detector array is at 90 degrees to light entering the polarizing beam splitter.

7. The array-based optical head of claim 1, additionally comprising:
a digital light processor array, configured to receive light from the polarizing beam splitter and to return modulated light to the polarizing beam splitter during a write mode.

8. The array-based optical head of claim 7, wherein the digital light processor array comprises an array of micro mirrors, wherein each of the micro mirrors is configured to move in response to a signal representing data, thereby modulating the light.

9. The array-based optical head of claim 1, additionally comprising:
a quarter-wave plate to rotate polarization of light traveling between the polarizing beam splitter and a digital light processor array; and
a quarter-wave plate to rotate polarization of light traveling between the polarizing beam splitter and the optical media.

10. An optical system, comprising:
an array-based optical head;
a checkered data pattern on optical media; and
a laser controller to turn on a laser within the array-based optical head when the checkered data pattern is in alignment with the array-based optical head and to turn off the laser during times when the checkered data pattern is not in alignment with the array-based optical head.

11. The optical system of claim 10, wherein the array-based optical head comprises:
a polarizing beam splitter, to pass light from the laser or to redirect the light from the laser according to polarity of the light.

12. The optical system of claim 10, wherein the array-based optical head comprises:
a digital light processor array, configured to modulate light when the optical system is in a write mode.

13. The optical system of claim 10, wherein the array-based optical head comprises:
a photodetector array to receive light after being modulated from contact with the optical media and to create an output signal when the optical system is in a read mode.

14. The optical system of claim 10, additionally comprising:
a digital light processor array controller to operate a digital light processor array in concert with movement of the optical media to write a checkered data pattern on the optical media.

15. The optical system of claim 14, wherein selected reflective elements within the digital light processor array reflect light during a write mode according to data sent to the digital light processor array controller, and wherein all of the reflective elements are configured to reflect light during a read mode.

16. A method to read data, comprising:
aligning locations, within which checkered optical data patterns are defined on an optical media, with an array-based optical head;
receiving, with the array-based optical head, modulated laser pulses
reflected off the checkered optical data patterns; and decoding the modulated laser pulses to formulate a data signal.

17. The method of claim 16, wherein the aligning comprises coordinating disc rotation speed and radial position of the array-based optical head.

18. The method of claim 16, wherein the receiving comprises:
directing the modulate laser pulses into a photodetector array.

19. The method of claim 16, wherein the decoding comprises:
recognizing patterns within the checkered optical data patterns.

20. The method of claim 16, additionally comprising:
passing laser pulses through a polarizing beam splitter;
passing laser pulses exiting the polarizing beam splitter through a quarter wave plate and a focusing lens prior to contact with the checkered optical data patterns and after reflection from the checkered optical data patterns;
passing the returned laser pulses through the polarizing beam splitter; and
directing the laser pulses to a photodetector array.

21. A method to write data on optical media, comprising:
pulsing a laser when locations on the optical media, to which checkered optical data patterns are to be written, become aligned with an array-based optical head;
coding data to determine the checkered optical data patterns to be written; and
modulating the laser pulses according to the coded data to write the checkered optical data patterns onto the optical media.

22. The method of claim 21, wherein the pulsing comprises:
rotating the optical media;
adjusting a position of the array-based optical head along a radius of the optical media;
coordinating rotation speed of the optical media and radial position of the array-based optical head; and
turning the laser on at times when the checkered optical data patterns defined on the optical media are in alignment with the array-based optical head and off at other times.

23. The method of claim 21, wherein the coding comprises selecting checkered optical data patterns which represent the data using a look-up table.

24. The method of claim 21, wherein the modulating comprises:
processing the laser pulse using a digital light processor array.

25. The method of claim 21, wherein the modulating comprises:
passing modulated laser pulses through a polarizing beam splitter to the optical media.

26. The method of claim 21, wherein the modulating comprises:
receiving the data; and
operating a digital light processor array with the data.

27. The method of claim 21, additionally comprising:
passing collimated laser pulses through a polarizing beam splitter;
passing the laser pulses exiting the polarizing beam splitter through a quarter wave plate;
reflecting the laser pulses exiting the quarter wave plate off a digital light processor array;
passing the laser pulses leaving the digital light processor array back through the quarter wave plate;
passing the laser pulses leaving the quarter wave plate through the polarizing beam splitter; and
directing the laser pulses to the optical media.

28. An optical media, comprising:
an elongated spiraling track; and
checkered data patterns spaced at intervals along the elongated spiraling track.

29. The optical media of claim 28, wherein the checkered data patterns comprise an N-by-N array of data elements, wherein N is an integer greater than one.

30. The optical media of claim 28, wherein the checkered data patterns comprise an M-by-N array of data elements, wherein M and N are integers, at least one of M and N is greater than one.

31. The optical media of claim 28, wherein the checkered data patterns comprise a grouping of data elements not configured as an array.

32. An array-based optical head, comprising:
means for directing the laser beam to optical media; and
means for receiving light modulated by reflection off a checkered data pattern on the optical media and for creating an output signal corresponding to the modulated light.

33. The array-based optical head of claim 32, additionally comprising:
means for creating a laser beam.

34. The array-based optical head of claim 32, additionally comprising:
means for rotating polarization of light traveling between the means for directing the laser beam to the optical media and the means for receiving the modulated light.

35. The array-based optical head of claim 32, additionally comprising:
means for rotating polarization of light traveling between the means for directing the laser beam and the optical media.

36. The array-based optical head of claim 32, additionally comprising means for modulating the laser beam to create the checkered pattern on the media.
